(19) United States
(12) Patent Application Publication
(10) Pub. No.: US 2015/0266198 A1
(43) Pub. Date: Sep. 24, 2015

(54) Cutting Head for an Ultrasonic Cutting Device

(71) Applicant: Bayerische Motoren Werke Aktiengesellschaft, Muenchen (DE)

(72) Inventors: Markus HUBER, Woerth (DE); Marc-Christian HEILMEIER, Viecht (DE); Eva HONICKEL, Landshut (DE)

(21) Appl. No.: 14/734,413

(22) Filed: Jun. 9, 2015

Related U.S. Application Data
(63) Continuation of application No. PCT/EP2013/074703, filed on Nov. 26, 2013.

(30) Foreign Application Priority Data
Dec. 19, 2012 (DE) 10 2012 223 785.2

(51) Int. Cl. B26D 7/08; B26D 3/10

(52) U.S. Cl. CPC B26D 7/086; B26D 3/10

(57) ABSTRACT

A cutting head for an ultrasonic cutting device includes an ultrasonic system with a cutting blade and a sonotrode. The ultrasonic system is mounted rotatably about an axis of rotation.

### CROSS REFERENCE TO RELATED APPLICATIONS

This application is a continuation of PCT International Application No. PCT/EP2013/074703, filed Nov. 26, 2013, which claims priority under 35 U.S.C. §119 from German Patent Application No. 10 2012 223 785.2, filed Dec. 19, 2012, the entire disclosures of which are herein expressly incorporated by reference.

### BACKGROUND AND SUMMARY OF THE INVENTION

The present invention relates to a cutting head for an ultrasonic cutting device and to an ultrasonic cutting device comprising such a cutting head.

Ultrasonic cutting devices are known in principle. They are used, for example, to cut to size semi-finished products for fiber composites. To this end, in particular, three-dimensionally complex geometries of fiber composite semi-finished products are cut to size around the edge. This cutting is frequently carried out by ultrasonic cutting devices, which include a robotic mechanism. Such a robotic mechanism, in particular a robotic arm, can be designed to be movable in up to six axes, for example. The cutting head is typically disposed at the end of such a robotic arm so as to carry out the cutting operation.

The drawback of such ultrasonic cutting devices is that the ultrasonic cutting device must carry out very complex movements by the cutting head. For example, if a robotic arm is provided, very large and wide-range cutting movements must be carried out in the case of complex geometries. This results in increased space requirement for the installation of such an ultrasonic cutting device. It is also disadvantageous that the requirement for the ultrasonic cutting device to carry out expansive movements is accompanied by a relative high need for time. However, when the cutting operation is carried out on a semi-finished product, such as in the form of a fiber composite semi-finished product, the time expenditure for the tracking of the cutting head is crucial for the entire time that is needed. The increased movement requirement, and consequently the increased need for time, thus cause longer cycle times for carrying out the cutting process. Moreover, the increased movement requirement for the robotic arm of the ultrasonic cutting device also entails increased loads on the individual joints as well as increased wear of a hose assembly to supply media along the robotic arm.

It is the object of the present invention to at least partially eliminate the above-described disadvantages. It is in particular the object of the present invention to provide a cutting head for an ultrasonic cutting device, and to provide such an ultrasonic cutting device which, in a cost-effective and simple manner, allows a reduced space requirement and/or a reduced processing time for the cutting of fiber composite semi-finished products.

The above object is achieved by a cutting head and by an ultrasonic cutting device, according to the invention. It goes without saying that features and details that are described in connection with the cutting head according to the invention also apply in connection with the ultrasonic cutting device according to the invention, and conversely, so that mutual reference is made, or can be made, in each case to the individual aspects of the invention with respect to the disclosure.

A cutting head according to the invention for an ultrasonic cutting device includes an ultrasonic system having a cutting blade and a sonotrode. A cutting head according to the invention is characterized in that the ultrasonic system is mounted rotatably about a rotational axis.

The ultrasonic cutting device is preferably implemented in the known manner. For example, the cutting head can be disposed at one end of the robotic arm of the ultrasonic cutting device. The ultrasonic system itself is likewise designed in the known manner. For example, it is provided with a cutting blade and a sonotrode, which together carry out the cutting process. The cutting blade itself has at least one edge, which directly carries out the cutting process. So as to extend the life of the edge of the cutting blade, while also improving the speed of the cutting operation, this cutting blade is rigidly connected to the sonotrode. The sonotrode is designed to oscillate at high frequency and thus to generate high-frequency oscillation on the cutting blade. In other words, the cutting blade is likewise caused to oscillate by the high-frequency oscillation of the sonotrode. In this way, cutting movements or sawing movements in the micrometer range are generated at the edge of the cutting blade. When such a cutting blade of an ultrasonic system, together with the cutting head, moves along the edge of a fiber composite semi-finished product for cutting the same, the cutting of the edge can be carried out with an increased useful life and also with increased speed.

However, compared to known cutting heads, the ultrasonic system is mounted rotatably about a rotational axis on a cutting head according to the invention. This means that a rotation, in particular an active rotation, of the ultrasonic system, and thus above all of the edge of the cutting blade, can be carried out. A rotation of the edge of the cutting blade allows at least partial tracking of even complex geometries due to the rotation of the ultrasonic system. If the tracking of complex geometries is at least partially provided for by a rotation of the ultrasonic system, tracking by a robotic arm of the ultrasonic cutting device is accordingly reduced.

It can be summarized that, when using a cutting head according to the invention, at least a portion of the movement that is required for the cutting blade during the cutting of edges can be made available by the rotation of the ultrasonic system. The necessary need of the robotic arm of the ultrasonic cutting device to move is thus accordingly reduced by this portion. The necessary movement of the edge is thus divided into a movement by rotation of the ultrasonic system and a movement by the ultrasonic cutting device or the robotic arm. Consequently, the necessary need for movement on the part of a robotic arm of the ultrasonic cutting device is considerably reduced. A further advantage is the fact that the rotatability of the blade and the symmetrical edge shape of the blade allow the blade to be rotated after every cut, so as to achieve even wear of the edges. This increases the useful life of the blade.

As a result of the reduced need for movement on the part of a robotic arm of the ultrasonic cutting device, the necessary space requirement is also reduced. The reduced movement accordingly also reduces the processing time since the robotic arm is able to carry out the necessary movement in a shorter time. It shall be pointed out that, due to the compact dimensions of the ultrasonic system, a rotational movement of the ultrasonic system itself can be carried out considerably more quickly, and notably in a space-saving manner compared to a corresponding movement of the ultrasonic cutting device. A cutting head according to the invention thus makes a reduced cycle time possible, and in particular also a reduced installation space requirement for the ultrasonic cutting device.

Given the rotatory mounting of the ultrasonic system, the rotatory mounting of the cutting blade and the edge thereof is particularly important. However, since the cutting blade and the sonotrode are frequently rigidly connected to each other so as to transmit the high-frequency oscillation from the sonotrode to the cutting blade, the entire ultrasonic system can preferably be mounted rotatably about the rotational axis. This further reduces the complexity of a necessary movement of the robotic arm.

The cutting blade can have one edge, or also multiple edges, for this purpose. It is preferred that at least one of the edges is disposed at an acute angle with respect to the rotational axis so as to further reinforce the effect of the rotatory movement of the ultrasonic system yet again.

Naturally, the cutting head can be designed with a mechanical interface or an interface having a different design, so as to allow the ultrasonic cutting device to grip the same or allow the same to be attached to the ultrasonic cutting device. Such an interface can be a standard mechanical interface, for example, so that a standard robotic arm is able to grip the cutting head. The ultrasonic cutting device is preferably provided at least with one robotic device or a robotic arm.

In particular, frequencies in the range of approximately 20 kHz are provided to excite the ultrasonic system. The mounting of the ultrasonic system is preferably disposed in a rotatable manner within a housing or a plate system of the cutting head. To this end, a wide variety of bearing systems or bearing means can be used, as will be described further hereafter. The rotatability about the rotational axis does not necessarily have to be arbitrary or free. It may rather suffice if a rotatability by ±180° or even less is provided for. However, a rotatability by substantially the full 360° is also contemplated. Reduced rotatability in a predefined rotational range can offer advantages, in particular with respect to the necessary supply of media (notably, power supply) to the ultrasonic system. The axis of rotation, or the rotational axis, of the ultrasonic system thus forms an additional rotational axis. If the ultrasonic cutting device comprises a robotic arm having typically up to six axes of rotation, the rotational axis of the ultrasonic system essentially additionally forms a seventh axis of rotation.

A cutting head according to the invention can be refined to the effect that the ultrasonic system includes a booster for converting electrical oscillation into mechanical oscillation. Such a booster is used to convert electrical oscillation, which is generated by a generator, for example, into the required mechanical oscillation at the sonotrode. The booster is thus preferably likewise a component of the ultrasonic system, so that the booster can be moved together with the sonotrode and the cutting blade about the rotational axis. The booster can be a piezo system, for example, which is able to convert the incoming electrical oscillations into the desired mechanical oscillations. To this end, the generator is preferably designed separately from the cutting head. The generator can, in particular, be even provided separately from the ultrasonic cutting device and be made available as a generator for a plurality of different ultrasonic cutting devices, for example. The oscillations generated in a mechanical fashion by the booster are preferably in the range of the natural frequency of the sonotrode and/or of the cutting blade. This improves the resulting frequency amplitude even further, whereby an improvement in the cutting operation can be achieved in the desired manner, along with an increased useful life of the cutting blade.

It can likewise be advantageous for the cutting blade of a cutting head according to the invention to have at least two edges, which are disposed at an acute angle with respect to the rotational axis. Providing a cutting blade having at least two edges essentially doubles the number of edges. These edges are preferably oriented with different angles at an acute angle with respect to the rotational axis. In this way, flexibility during use of the cutting blade can be increased even further. In particular, the necessary movement about the rotational axis can be reduced, so that free rotatability in the range of ±90° suffices, for example. Depending on the rotational position of the ultrasonic system and the presently required positioning of the edge, it is thus possible to use one or the other of the two edges. Naturally, however, more than two edges, such as three or even more edges, are contemplated within the meaning of the present invention.

It can likewise be advantageous when the cutting blade of a cutting head according to the invention as described in the preceding paragraph is designed in the shape of a triangle, and more particularly in the shape of an isosceles triangle. This reduces the cost expenditure as well as the complexity in the production of a cutting blade according to the invention. If the cutting blade is designed in the shape of an isosceles triangle, the two equal sides together preferably form the two edges. The symmetrical configuration allows particularly simple, and above all substantially error-free, use of the cutting blade on the sonotrode. The susceptibility to errors when retrofitting or servicing a cutting head according to the invention is thus reduced.

A further advantage is achieved when the tip between the two edges of a cutting head according to the invention is located on, or substantially on, the rotational axis. This likewise reduces the complexity of a cutting head according to the invention. In particular, the mechanical oscillation is passed on equally to the two edges of the cutting head. As a result, a distinction of which of the two edges is presently in cutting action is no longer required for controlling the cutting operation. The two edges are thus separated completely by the rotational axis. The point of intersection of the extension of the two edges is thus located on the rotational axis.

It is further likewise advantageous when at least one interface, in particular a mechanical interface, is formed on a cutting head according to the invention for the connection to the ultrasonic cutting device and/or a media interface for supplying the ultrasonic system with media. Such an interface allows a connection in particular to existing ultrasonic cutting devices or to known robotic arms. A mechanical interface for this purpose is the attachment of the cutting head to the robotic arm of an ultrasonic cutting device. This interface can be provided in a positive fit manner, for example. The media interface is preferably formed by way of plug-in devices. The media supply shall be understood to mean, in particular, the connection for the supply of power or similar media, including also the ultrasonic frequency.

It is a further advantage when at least one drive is provided on a cutting head according to the invention, which is designed to move the ultrasonic system about the rotational axis. This drive can be an electric motor, for example, in particular an electric stepper motor or a frequency converter. The same is designed to be so small that it is part of the cutting head, and in particular it is disposed within a housing of the cutting head. This drive is preferably supplied via the above-described media interface.

It is likewise further advantageous when the ultrasonic system of a cutting head according to the invention is mounted rotatably about the rotational axis by way of bearings, in particular in the form of a roller bearing and/or a sliding bearing. Roller bearings and sliding bearings are particularly cost-effective embodiments of such bearings. However, other bearings are naturally also contemplated within the meaning of the present invention. The mounting preferably takes place in a housing of the cutting head or a corresponding bearing plate of the cutting head.

It can likewise be advantageous when at least one towing connection is provided on a cutting head according to the invention so as to supply the rotatably mounted ultrasonic system with media. This towing connection is provided with the ultrasonic system at one end, and with a plug connection at the other end, wherein the plug connection preferably forms the media interface. The towing connection thus allows a connection relative to the cutting head in the form of the media interface, and a connection rotating relative thereto to the ultrasonic system. In this way, for example, a cable conduit chain can be provided, which forms the towing connection. The mobility of the towing connection is preferably adapted to the maximal rotational angle of the ultrasonic system relative to the rotational axis thereof.

A further advantage is achieved when a parallel offset is formed on a cutting head according to the invention between the rotational axis and a connecting axis to the ultrasonic cutting device, in particular a connecting axis of the mechanical interface. This means that the rotational axis and the connecting axis are not located coaxially to each other. If the mechanical interface is implemented for connection to a robotic arm, parallel spacing may offer greater freedom when carrying out the cutting process. The connecting axis is then preferably likewise a rotational axis, such as the sixth axis of a robotic arm.

The present invention likewise relates to an ultrasonic cutting device including a cutting arm and at least one cutting head, which is attached to the cutting arm. An ultrasonic cutting device according to the invention is characterized in that the cutting head is designed in accordance with the invention. An ultrasonic cutting device according to the invention accordingly entails the same advantages as those that were described in detail with respect to a cutting head according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of an embodiment of a cutting head according to the invention; and

FIG. 2 is a schematic diagram of an embodiment of an ultrasonic cutting device according to the invention.

### DETAILED DESCRIPTION OF THE DRAWINGS

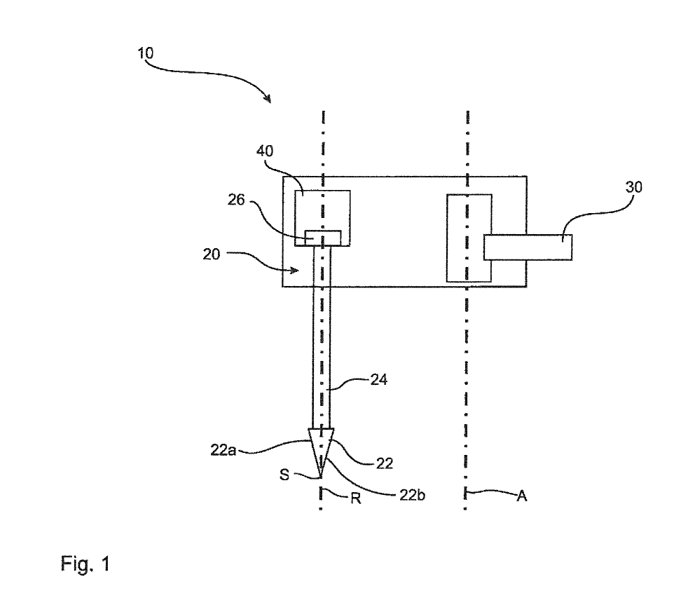

FIG. 1 shows a first embodiment of a cutting head 10. The head includes an ultrasonic system 20. The ultrasonic system 20 is designed with a cutting blade 22 and a rod-shaped sonotrode 24. Moreover, a booster 26 is provided, which is able to convert electrically generated or incoming oscillation, for example in the form of a piezo system, into mechanical oscillation for the sonotrode 24.

In this embodiment, the cutting blade 22 is designed substantially as an isosceles triangle. The two equal sides of this isosceles triangle are formed by two edges 22a and 22b. The tip S of this isosceles triangle is located on the rotational axis R. The entire ultrasonic system 20 is mounted on the cutting head 10 so as to be rotatable about this rotational axis R.

So as to be able to actively provide, and in particular also control, the rotatability about the rotational axis R, a drive device 40 is provided. This device is designed in the manner of an electric motor, for example, and connected to the ultrasonic system 20 in an accordingly torque-transmitting manner.

The cutting head 10 of this embodiment moreover has an interface 30 in the form of a mechanical interface. A robotic arm, which is not shown, of an ultrasonic cutting device 100 can engage with this interface. At the same time, the option of a rotation about this mechanical interface 30 is provided, which is to say about a corresponding connecting axis A. As is easily apparent from FIG. 1, a parallel offset exists between the rotational axis R and the connecting axis A. During a rotation based on this parallel offset, higher flexibility can accordingly be achieved during use for a cutting operation.

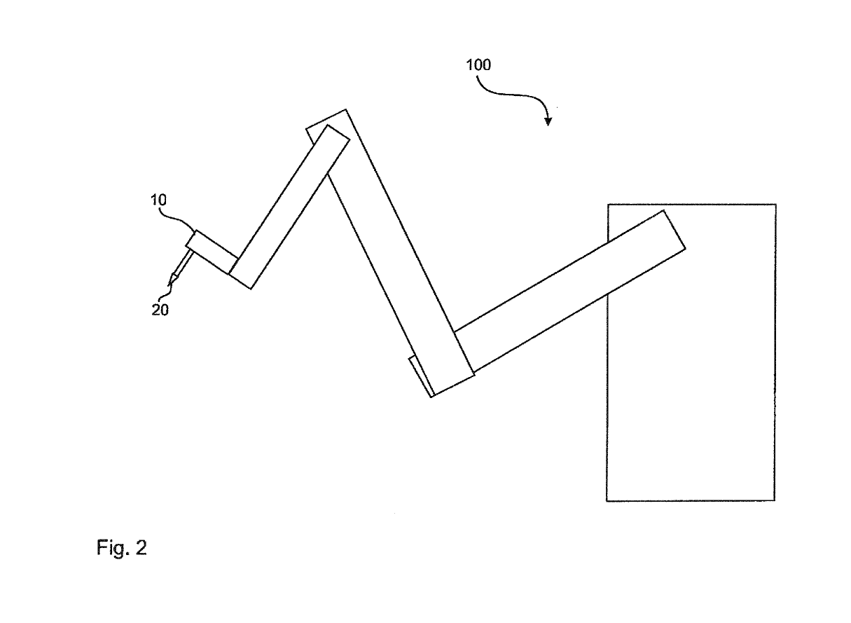

FIG. 2 shows an embodiment of an ultrasonic cutting device 100. This device is provided with a robotic arm in the form of a cutting arm 110. A cutting head 10 having a cutting blade 20 is disposed at the end of this cutting arm 110. This cutting head is preferably designed as shown in FIG. 1.

The above description of the embodiments describes the present invention exclusively based on examples. Individual features of the embodiments, provided they are technically expedient, can, of course, be freely combined with each other without departing from the scope of the present invention.

### LIST OF REFERENCE NUMERALS

10 cutting head
20 ultrasonic system
22 cutting blade
22a edge
22b edge
24 sonotrode
26 booster
30 interface
40 drive device
100 ultrasonic cutting device
110 cutting arm
A connecting axis
R rotational axis
S tip

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cutting head for an ultrasonic cutter, comprising:
an ultrasonic system, the ultrasonic system having a cutting blade and a sonotrode, wherein
the ultrasonic system is mounted rotatably about a rotational axis.

2. The cutting head according to claim 1, wherein the ultrasonic system further comprises a booster operatively configured to convert electrical oscillation into mechanical oscillation.

3. The cutting head according to claim 1, wherein the cutting blade has at least two edges, the two edges being disposed at an acute angle with respect to the rotational axis.

4. The cutting head according to claim 2, wherein the cutting blade has at least two edges, the two edges being disposed at an acute angle with respect to the rotational axis.

5. The cutting head according to claim 3, wherein the cutting blade has a triangular shape.

6. The cutting head according to claim 3, wherein the cutting blade has an isosceles triangle shape.

7. The cutting head according to claim 3, wherein a tip between the two edges of the cutting blade is located substantially on the rotational axis.

8. The cutting head according to claim 6, wherein a tip between the two edges of the cutting blade is located substantially on the rotational axis.

9. The cutting head according to claim 1, wherein the ultrasonic system further comprises a mechanical interface configured to connect with at least one of the ultrasonic cutter or a media interface for supplying the ultrasonic system with media.

10. The cutting head according to claim 1, wherein the ultrasonic system further comprises at least one drive configured to move the ultrasonic system about the rotational axis.

11. The cutting head according to claim 10, wherein the ultrasonic system is mounted rotatably about the rotational axis via at least one bearing.

12. The cutting head according to claim 11, wherein the bearing is at least one of a roller bearing or a sliding bearing.

13. The cutting head according to claim 1, further comprising at least one towing connection provided so as to supply the rotatably mounted ultrasonic system with media.

14. The cutting head according to claim 9, wherein the mechanical interface has a connecting axis, and further wherein the rotational axis about which the ultrasonic system is mounted rotatably and the connecting axis of the mechanical interface are arranged parallel and offset with respect to one another.

15. An ultrasonic cutter, comprising:
a cutting arm;
a cutting head attached to the cutting arm, the cutting head comprising:
an ultrasonic system, the ultrasonic system having a cutting blade and a sonotrode, wherein
the ultrasonic system is mounted rotatably about a rotational axis.
